(19) United States
(12) Patent Application Publication
(10) Pub. No.: US 2004/0218199 A1
(43) Pub. Date: Nov. 4, 2004

(54) Printer calibration system and method

(76) Inventors: Laurent A. Regimbal, Round Rock, TX (US); David E. Smith, Emmett, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/426,603

(22) Filed: Apr. 30, 2003

(51) Int. Cl. G06F 15/00; H04N 1/00

(52) U.S. Cl. 358/1.9; 358/406

(57) ABSTRACT

A calibration system and method for printers is described. In one exemplary implementation, an apparatus includes a print mechanism configured to apply images to a print medium and a calibration system configured to calibrate the print mechanism. The calibration system divides a calibration process into a plurality of partial calibration tasks that are performed at different intervals separated by non-calibration tasks.

### TECHNICAL FIELD

The present invention relates generally to monochrome and color printing systems, and more specifically, to calibrating such printing systems.

### BACKGROUND

Most printers are rated by how fast they can produce printed documents and the print quality of the printed documents produced. In printers, especially high quality monochrome and color printers, calibration is necessary to ensure proper print quality of images output by the printers on a printable medium. Printers are usually calibrated when powered-up and again at later predetermined intervals during operation.

There are many types of calibration processes that need to be performed to ensure proper print quality. For example, one calibration process involves making certain that multiple imaging systems within the printers unite properly to form a single image. Typically, these multiple systems are not co-located and attempts (e.g., measurements, tests and adjustments) are constantly being made to check and align these systems. This is referred to as color plane registration (CPR) and involves the lining-up of different color planes within printers. Other calibration procedures may involve measuring color densities, color variations, and gloss levels produced by printers, as well as performing other calibration processes.

Unfortunately, calibration is a time consuming process, often delaying and/or interrupting document print production. When calibration is performed, most printers typically go into a calibration mode at which time document print production is halted until the calibration is complete. At this point users of such printers have to wait until the calibration process is completed before their print requests are actively processed by the printers. This reduces the overall speed of the printers and degrades the overall efficiency rating of the printers. Moreover, users of the printers may find the calibration process to be frustrating, because they often have to wait for the calibration process to finish before their print requests can be completed.

Many contemporary printers attempt to reduce the delays associated with performing calibrations, but as demands for higher quality printed documents continue to increase, the calibrations tend to be more complex and require more time to be performed. Consequently, calibrations are becoming ever more critical with each new generation of printers due to the demand for higher print qualities, yet at the same time there is an increased demand for faster throughput unimpeded by calibration interrupts. Currently, there is no satisfactory solution to satisfy both of these demands.

### SUMMARY

A calibration system and method for printers is described. In one exemplary implementation, an apparatus includes a print mechanism configured to apply images to a print medium and a calibration system configured to calibrate the print mechanism. The calibration system divides a calibration process into a plurality of partial calibration tasks that are performed at different intervals separated by non-calibration tasks.

### BRIEF DESCRIPTION OF THE DRAWINGS

The detailed description is described with reference to the accompanying figures. In the figures, the left-most digit(s) of a reference number identifies the figure in which the reference number first appears.

FIG. 1 illustrates various components of an exemplary printer that can be utilized to implement the inventive techniques described herein.

FIG. 2 illustrates exemplary embodiments of select elements from a printer including a calibration system and a print unit.

FIG. 3 is a conceptual diagram illustrating an exemplary calibration process divided into a plurality of one or more partial calibration tasks separated by one or more non-calibrations tasks.

FIG. 4 illustrates an exemplary page of a document to be printed by a printer.

FIG. 5 is a flow chart illustrating one exemplary method for performing partial calibration tasks in inner document gaps (open areas).

### DETAILED DESCRIPTION

### Introduction

In some state-of-the art, higher quality printers, up to approximately five minutes are spent performing calibrations. As explained above, these calibrations are required to maintain print quality. To overcome these inefficiencies and problems, the following description introduces the broad concept of performing a plurality of partial calibration operations interposed between non-calibration operations. In other words, calibration operations are performed in a time share fashion with non-calibration operations. As a result, the calibrations themselves, become transparent to the end user, because a user's printed output is not halted or interrupted while the printer performs the plurality of partial calibrations.

In one exemplary implementation, marks, associated with each of the plurality of partial calibrations, are placed on some type of test element, then they are measured and cleaned-off prior to printable media coming into contact with the test element. The partial calibrations can be performed during inter-page gaps or areas where images are not present in documents, such as margin spaces or gaps between images in the documents.

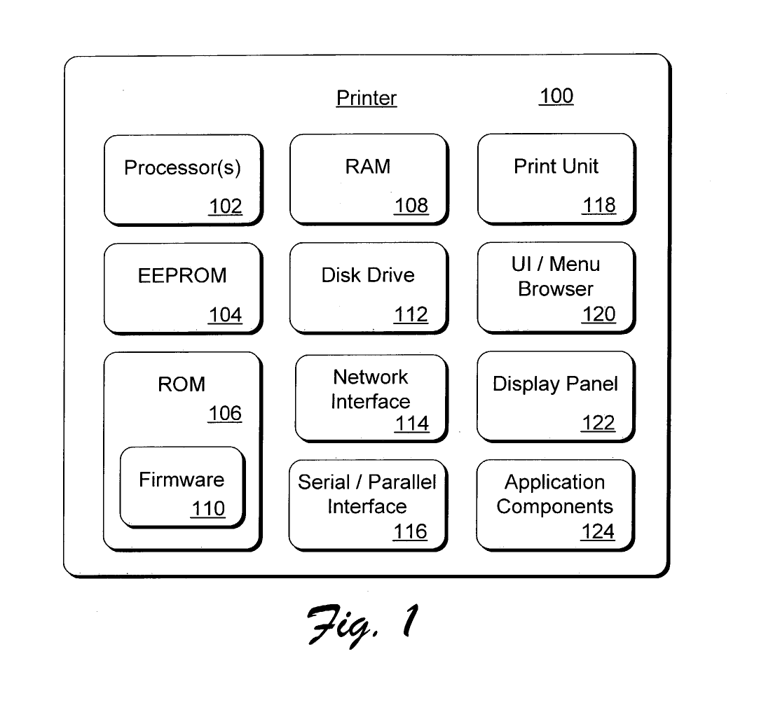

Exemplary Printing Device Architecture FIG. 1 illustrates various components of an exemplary printer 100 that can be utilized to implement the inventive techniques described herein. Printer 100 may include one or more processors 102, an electrically erasable programmable read-only memory (EEPROM) 104, ROM 106 (non-erasable), and a random access memory (RAM) 108. Although printer 100 is illustrated having an EEPROM 104 and ROM 106, a particular printer may only include one of the memory components. Additionally, although not shown, a system bus typically connects the various components within printer 100.

Printer 100 may include a firmware component 110 that is implemented as a permanent memory module stored on ROM 106. Firmware 110 is programmed and tested like software, and is distributed with printer 100 or replaced by updates. Firmware 110 can be implemented to coordinate operations of the hardware within printer 100 and contains programming constructs used to perform such operations.

Processor(s) 102 process various instructions to control the operation of the printer 100 and to communicate with other electronic and computing devices. The memory components, EEPROM 104, ROM 106, and RAM 108, store various information and/or data such as configuration information, fonts, templates, data being printed, and menu structure information. Although not shown, a particular printer can also include a flash memory device in place of or in addition to EEPROM 104 and ROM 106.

Printer 100 may also include a disk drive 112, a network interface 114, and a serial/parallel interface 116. Disk drive 112 provides additional storage for data being printed or other information maintained by printer 100. Although printer 100 is illustrated having both RAM 108 and a disk drive 112, a particular printer may include either RAM 108 or disk drive 112, depending on the storage needs of the printer. For example, an inexpensive printer may include a small amount of RAM 108 and no disk drive 112, thereby reducing the manufacturing cost of the printer.

Network interface 114 provides a connection between printer 100 and a data communication network. Network interface 114 allows devices coupled to a common data communication network to send print jobs, menu data, and other information to printer 100 via the network. Similarly, serial/parallel interface 116 provides a data communication path directly between printer 100 and another electronic or computing device. Although printer 100 is illustrated having a network interface 114 and serial/parallel interface 116, a particular printer may only include one interface component.

Printer 100 also includes a print unit 118 that includes mechanisms arranged to selectively apply an imaging medium such as liquid ink, toner, and the like to a print media in accordance with print data corresponding to a print job. Print media can include any form of media used for printing such as paper, plastic, fabric, Mylar, transparencies, and the like, and different sizes and types such as 8½×11, A4, roll feed media, etc. For example, print unit 118 can include an inkjet printing mechanism that selectively causes ink to be applied to a print media in a controlled fashion. The ink on the print media can then be more permanently fixed to the print media, for example, by selectively applying conductive or radiant thermal energy to the ink. Those skilled in the art will recognize that there are many different types of print units available, and that for the purposes of the present invention, print unit 118 can include any of these different types.

Printer 100 may also include a user interface and menu browser 120, and a display panel 122. The user interface and menu browser 120 allows a user of the printer 100 to navigate the printer's menu structure. User interface 120 can be indicators or a series of buttons, switches, or other selectable controls that are manipulated by a user of the printer. Display panel 122 is a graphical display that provides information regarding the status of printer 100 and the current options available to a user through the menu structure.

Printer 100 can, and typically does, include application components 124 that provide a runtime environment in which software applications or applets can run or execute. Those skilled in the art will recognize that there are many different types of runtime environments available. A runtime environment facilitates the extensibility of printer 100 by allowing various interfaces to be defined that, in turn, allow the application components 124 to interact with the printer.

General reference is made herein to one or more printing devices, such as printer 100. As used herein, “printer” means any electronic device having data communications, data storage capabilities, and/or functions to render printed characters and images on a print media. A printer may be a fax machine, copier, plotter, and includes any type of printing device using a transferred imaging medium, such as ejected ink, to create an image on a print media. Examples of such a printer can include, but are not limited to, laser printers, inkjet printers, plotters, portable printing devices, as well as multi-function combination devices. Although specific examples may refer to one or more of these printers, such examples are not meant to limit the scope of the claims or the description, but are meant to provide a specific understanding of the described implementations.

### Exemplary Calibration System

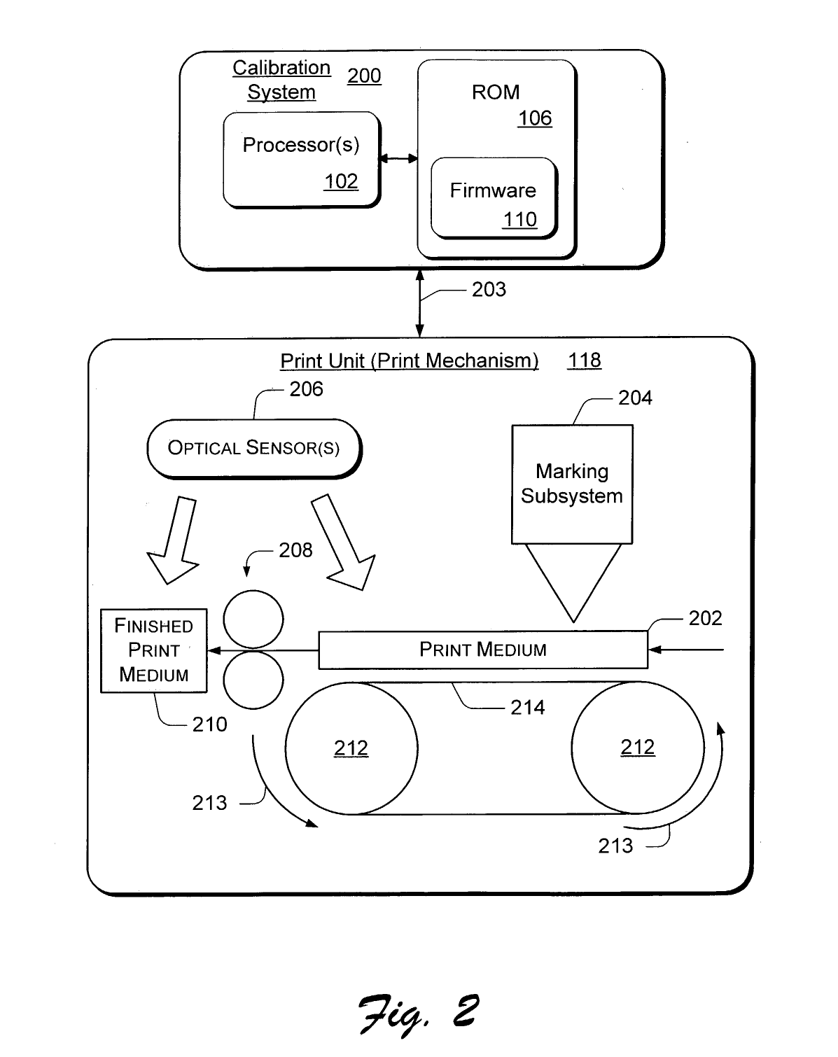

FIG. 2 illustrates select elements from printer 100 including a calibration system 200 and print unit 118. Calibration system 200 performs calibration tests of print unit 118 and uses the results to calibrate the print unit 118. In this example, calibration system 200 includes processor(s) 102, memory (ROM 106) and firmware 110. Calibration system 200 controls calibration of the printer 100 through the use of programmable logic and/or computer executable instructions stored in ROM 106. Processor(s) 102 executes various instructions stored in ROM 106 or in the form of firmware 110 to control the operation of the printer 100 and to communicate with other electronic, mechanical and computing devices. In particular, calibration system 200 serves as a controller for the print unit 118 and calibrations that are performed therein.

In other implementations, calibration system 200 can be implemented as pure hardware, firmware and/or software. Also, a processor 102 can be implemented as any type of processing device including, but not limited to: a state-machine, Digital Signal Processor (DSP), an Application Specific Integrated Circuit (ASIC), or as one or more processor chips. Additionally, it is to be appreciated that alternative types of computer-readable memory devices could be substituted in place of ROM 106 and or firmware 110. Thus, the computer-executable instructions (including programmable logic) could also be stored on any alternative computer-readable media (RAM, DVD, Flash, etc.) including directly onto a programmable logic processor, such as a Programmable Logic Array (PLA), ASIC and other programmable processing devices.

Print unit 118 generally includes the mechanical mechanisms arranged to selectively apply colorants in the form of liquid ink, toner, and the like to a print medium 202 in accordance with print data corresponding to a print request. Print unit 118 may include a marking subsystem 204, one or more sensor(s) 206, a fuser 208, rollers 212, and a test element 214. It is appreciated that print unit 118 is simplified for illustration purposes. Additional items can comprise the print unit 118 such as a motor (not shown) to drive the rollers 212.

Marking subsystem 204 is used to apply colorant (e.g., toner or ink) to the print medium 202 or the test element 214. As used herein the term colorant refers to a single pure color and/or a mixture of colorants that form a single colorant. When performing calibrations, marking subsystem 204 is instructed by the calibration system 200 to print a series of half-toned patches of one or more colorants on either the print medium 202 or the test element 214. Such calibrations may include, but are not limited to, performing color plane registration (CPR), measuring gloss levels, measuring colorant densities and levels and so forth. For example, when calibration system 200 performs CPR calibration system instructs marking subsystem 204 to apply tick marks to test element 214 and/or print medium 202.

Depending on the calibration being performed, sensor(s) 206 may sense various test patterns applied to the test element 214. For example, if measuring colorant levels, sensor(s) 206 sense the amount of colorant (e.g. colorant level) applied to the test element 214 and to the print medium 202. If performing CPR, sensor(s) 206 measure whether tick marks are in proper alignment. Regardless of the type of calibration performed, when enough measurements are collected and sent back to the calibration system 200 (via a communication link 203), calibration system 200 is able to adjust various devices in print unit 118 to ensure proper calibration.

The one or more sensors 206 may be implemented as an optical sensor, such as a densitometer, a calorimeter, a spectrophotometer or any other single or combinatory device capable of measuring colorants applied to a printable medium 202 or to the test element 214. In the example shown in FIG. 2, a single optical sensor 206 is positioned to detect colorant applied to the test element 214, but additional sensors could be added to the print unit 118 at various positions to measure various items relevant to calibration.

Rollers 212 provide a mechanism for moving the test element 214. By rotating the rollers 212 in the directions of the arrows 213, test element 214 rotates around the rollers in the same direction as the arrows 213. It is to be appreciated that FIG. 2 is simplified and that devices such as pulleys, duplex mechanisms, clips, belts and other related devices could be used to move the test element 214.

In the exemplary implementation, test element 214 is an electrostatic transport belt that permits images to be applied to the print medium 202. Alternatively, test element 214 could be a photoconductive drum. When in the form of a transport belt, test element 214 also serves to move the print medium 202 through the print unit 118 from an input area (not shown) to an output area (not shown). Colorants can be applied to the test element 214 and their colorant levels measured by the optical sensor 206 in order to calibrate the print unit 118 in conjunction with other operations which are controlled by the calibration system 200, all of which shall be described in more detail below.

The calibration system 200 and the print unit 118 shown in FIG. 2 are exemplary. It is expected that various types of other print units as well as calibration system configurations can be used in place of the exemplary illustrations. While other specific configurations may be substituted for calibration system 200 and print unit 118, it is appreciated that these various configurations can be successfully adapted to calibrate a printer in a similar fashion as described herein.

### Exemplary Calibration Processes

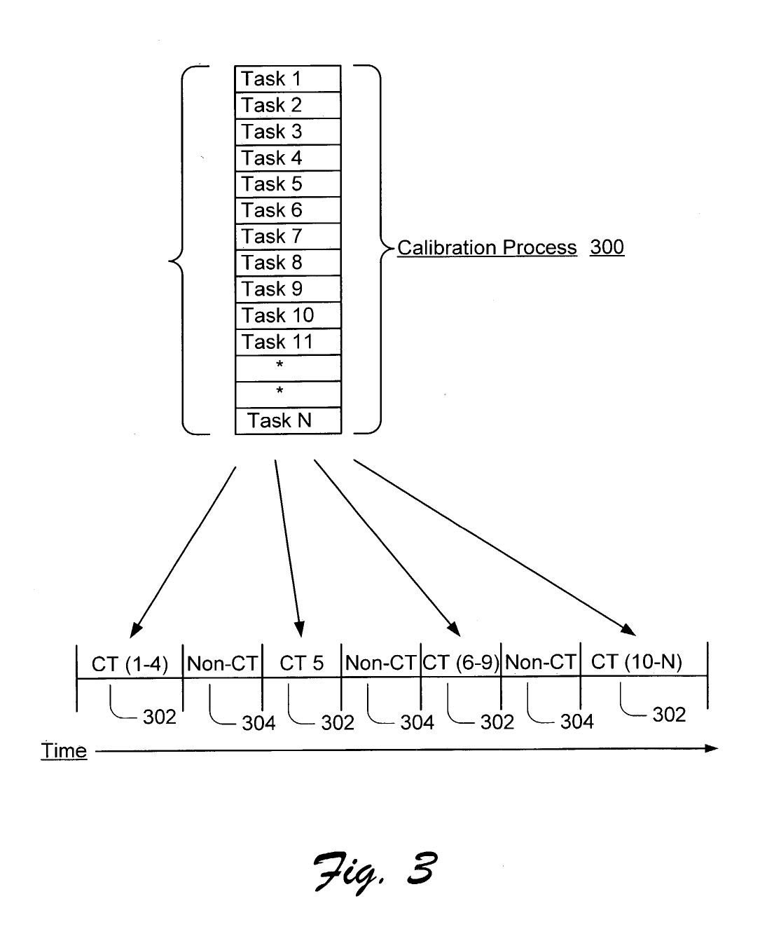

Calibration system 200 is configured to calibrate the print unit 118 by dividing a calibration process into a plurality of partial calibration tasks that are performed at different intervals separated by non-calibrations tasks. FIG. 3 is a conceptual diagram illustrating a complete calibration process 300 divided into a plurality of one or more partial calibration tasks 302 separated by one or more non-calibrations tasks 304.

Calibration process 300 includes a plurality of partial tasks necessary to enable the calibration of printer 100. In the exemplary diagram, calibration process includes calibration tasks 1 through N, where N represents any number of operations needed to calibrate a particular printer model. Each calibration task represents a specific operation performed by the calibration system 200. For example, calibration task 1 may consist of instructing the print unit 118 to clean the test element of any electrostatic marks. Calibration task 2 may consist of applying five marks to the test element and measuring their displacements. Calibration task 3 may consist of erasing the five marks and selecting a different color plane registration, and so forth, until calibration task N is performed, which represents the last partial calibration task performed in the calibration process 300.

It should be noted that a wide variety of calibration processes could be represented by calibration process 300. For example, calibration process 300 may represent performing CPR, calibrating color densities, calibrating glossiness of ink, calibrating color levels, as well as other processes used to calibrate a printer. While specific examples used herein may refer to only one of these example calibrations processes, the broad concepts represented by FIG. 3 can easily be applied to any of the wide variety of calibration processes represented by calibration process 300.

In a time line shown below calibration process 300 in FIG. 3, partial calibration tasks are abbreviated as “CT” and non-calibration tasks are abbreviated by “Non-CT”. One or more partial calibration tasks (CT) 302 are performed in increments separated by one or more non-calibration tasks (Non-CT) 304 over time. A non-calibration task represents any operation performed by printer 100 that is not part of the calibration process 300. For example, a non-calibration task can include relaying an image on to a printable medium, formatting a document, outputting paper from the print unit 118 to an output tray (not shown), etc. In certain instances it is possible to perform several partial calibration tasks uninterrupted (e.g., CT 1-4) and in other instances it may only be possible to perform one calibration task (e.g. CT 5) separated by one or more non-calibration tasks 304.

In one implementation, the amount of partial calibration task(s) selected between one or more non-calibrations tasks is dependent on the document being printed as shall be described. It is also possible to perform calibration tasks on a predetermined interval(s) dependent on time or the number of pages printed by a printer 100. No matter how partial calibration tasks are interposed with non-calibration tasks, it is desirable to perform one or more partial calibration tasks on some type of time sharing basis with non-calibration tasks to maximize throughput and performance of printer 100.

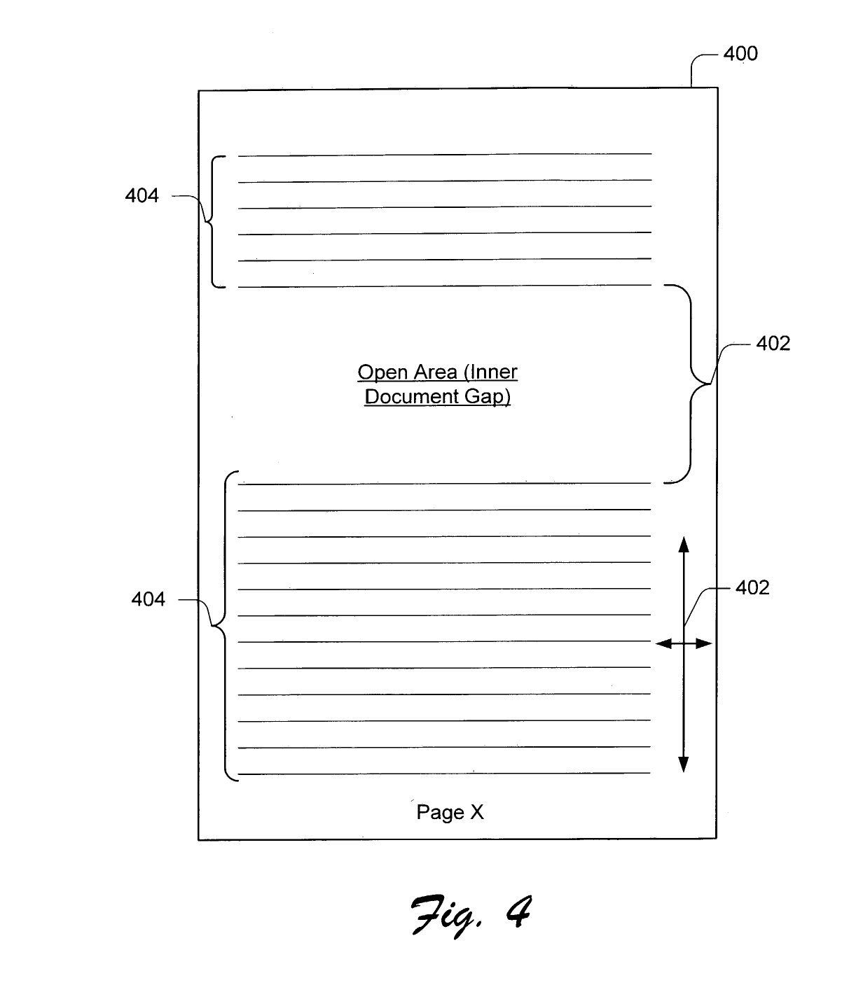

In one implementation, to reduce interruptions of non-calibration processes, calibration system 200 selects particular times when printing operations can be temporarily slowed-down and/or interrupted. FIG. 4 illustrates a page 400 of a document to be printed by printer 100. Page 400 includes several open areas 402 (also referred to as inner document gaps), which is a space or an area within a document or page where no printable image is intended to be positively printed. An open area 402 can consist of a margin, or gap between images 404. Images 404 include such things as text, pictures, clips, borders or other positive images to be displayed on a printable medium 210.

An open area 402 can also include those areas outside the region where it is possible to apply positive printable images onto the printable medium 210. For example, standard A4 paper is 11.69 inches in length and the print unit 118 is designed to apply images to print media that is much longer (e.g. standard American Letter Head which is 12+ inches in length). Thus, it is possible to apply images (such as tick marks) to areas outside the maximum length (or width) while printing on standard paper and not have to worry about the marks (test patterns) affecting the finished print medium 210.

Calibration system 200 locates open areas 402 and performs one or more partial calibrations at a time before the print unit 118 reaches that portion of a document where the open area exists. At that point, calibration system 200 slows the print unit down enough (if necessary) to perform one or more calibration tasks 302 and returns the print unit 118 back to printing of a document until additional partial calibration tasks 302 can be performed and/or calibration process 300 is complete. In the event, the print unit 118 is slowed down when performing partial calibrations tasks, typically the delay is minimal. Usually, the delay is not noticeable to a user, because the tasks are performed over time in the background and may be performed over a span of time including the printing of several documents.

In the exemplary implementation, the print unit is slowed down or momentarily stopped, when the test element 214 is going to come into contact with a point where an open area 402 is located on a page 400. At a location on the test element 214 (such as the electrostatic transport belt) corresponding to the open area 402, one or more partial calibration tasks are performed by the print unit 118 in response to control signals from the calibration system 200. These tasks can include (i) applying one or more print marks (i.e., test pattern associated with the type of calibration being performed) on to the test element 214 corresponding to the space allotted for the open area 402, (ii) performing one or more measurements, and (iii) cleaning or erasing, but when desirable) the one or more print marks off the test element 214. At this point the printable medium 202 (e.g., page 400 at open area 402) can come into contact with the test element 214, and the print job can be advanced. In one implementation, marks can be erased (cleaned) to allow for the re-use the test element 214 for subsequent calibrations.

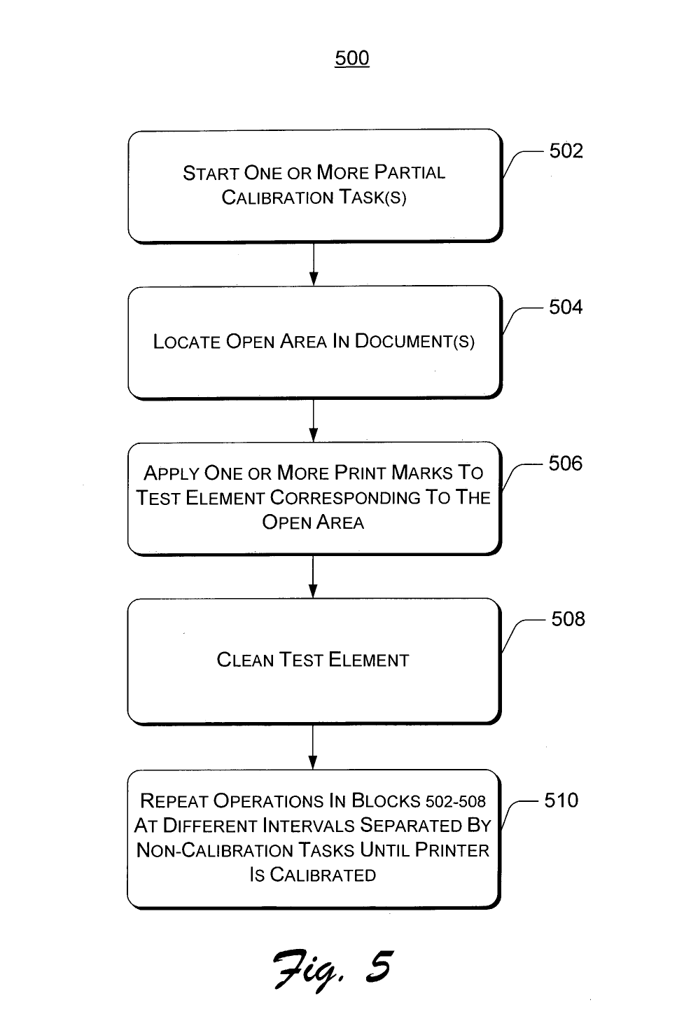

FIG. 5 is a flow chart illustrating one exemplary method 500 for performing partial calibration tasks 302 in inner document gaps (open areas) 402. The order in which the process is described (including any sub-processes) is not intended to be construed as a limitation. Furthermore, the method can be implemented in hardware, software, firmware, or any suitable combination thereof. In the exemplary implementation, method 500 is performed by calibration system 200 (one or more processors 102 executing programmable logic and/or code stored in memory).

At a block 502, calibration system 200 begins operations associated with calibrating a printer 100. Typically, a printer is calibrated when first powered-on (such as in the morning or after a period of inactivity) or at predetermined intervals. When calibration is initiated, calibration system 200 selects one or more partial calibration tasks 302 to be performed. In the exemplary implementation, the number of tasks performed can depend on the type of document being printed by the printer 100 or the type of calibration being performed.

For instance, at a block 504, calibration system 200 locates open areas 402 that represent inner document gaps in a document or other open areas where printable images are not to be deposited onto a printable medium.

At a block 506, calibration system 200 issues commands to the print unit to perform one or more calibration tasks associated with calibration. These tasks can include: (i) applying one or more print marks (i.e., test patterns) to a portion of the test element 214 corresponding to the open area 402; and (ii) measuring the one or more marks applied to the test element 214.

At a block 508, the print unit 118 cleans the one or more marks off the test element 214 prior to the print medium 202 (e.g., page 400) coming into contact with the portion of the test element 214 corresponding to the open area 402. This way calibration marks are erased so that the test element, such as an electrostatic belt does not leave any unintended marks in a document not specified by the print job request.

At a block 510, non-calibration operations are performed by printer 100 until a next partial calibration task can be performed. Accordingly, operations in blocks 502-510 will be performed in a time share fashion, interposed between non-calibration tasks, until a complete calibration process (such as calibration process 300) is performed.

Based on the forgoing, calibration processing can be completed in a much more efficient way than is possible in current printers.

Thus, although some preferred implementations of the various methods and arrangements of the present invention have been illustrated in the accompanying Drawings and described in the foregoing Detailed Description, it will be understood that the invention is not limited to the exemplary aspects disclosed, but is capable of numerous rearrangements, modifications and substitutions without departing from the spirit of the invention as set forth and defined by the following claims.

What is claimed is:

1. An apparatus, comprising:
a print mechanism configured to apply images to a print medium; and
a calibration system configured to calibrate the print mechanism by dividing a calibration process into a plurality of partial calibration tasks, wherein one or more of the plurality of partial calibration tasks are performed at different intervals separated by one or more non-calibration tasks.

2. The apparatus as recited in claim 1, wherein the calibration system is further configured to locate gaps between images applied to the print medium.

3. The apparatus as recited in claim 1, wherein the print mechanism comprises a test element configured to apply the images to the print medium; wherein the calibration system is configured to: (i) locate an open area on the print medium where images are not to be applied to the print medium; (ii) apply one or more print marks to a portion of the test element corresponding to the open area; (iii) measure the one or more marks applied to the test element; and (iv) clean the one or more marks off the test element prior to the print medium coming into contact with the portion of the transport element corresponding to the open area.

4. The apparatus as recited in claim 1, wherein the calibration process is completed when all the partial calibration tasks have been performed.

5. The apparatus as recited in claim 1, wherein the non-calibration tasks include applying images to the print medium.

6. A printer, comprising: a print mechanism; and a calibration system operable to calibrate the print mechanism according a plurality of partial calibration tasks, the partial calibration tasks being performed at different intervals separated by non-calibration tasks.

7. The printer as recited in claim 6, wherein the calibration system is further configured to perform one of the plurality partial calibration tasks in concert with the print mechanism at a time when the print mechanism is not performing a non-calibration task.

8. The printer as recited in claim 6, wherein the print mechanism comprises an electrostatic transport belt configured to apply images to a print medium; wherein the calibration system is configured to: (i) locate an open area on the print medium where images are not to be applied to the print medium; (ii) apply one or more print marks to a portion of the electrostatic transport belt corresponding to the open area where the images are not to be applied to the print medium; (iii) measure the one or more marks applied to the electrostatic transport belt; and (iv) clean the one or more marks off the electrostatic transport belt prior to the print medium coming into contact with that portion of the transport belt.

9. The printer as recited in claim 6, wherein the non-calibration tasks include applying images to a print medium.

10. A printer, comprising: a calibration system operable to calibrate the printer by breaking up tasks appurtenant to calibrating the printer and performing the tasks in increments separated by non-calibration tasks.

11. The printer as recited in claim 10, wherein the calibration system is further configured to perform one of the tasks in between two non-calibration tasks.

12. The printer as recited in claim 10, further comprising a print mechanism including an electrostatic transport belt configured to apply images to a print medium; wherein the calibration system (i) locates an open area on the print medium where images are not to be applied to the print medium; (ii) applies one or more print marks to a portion of the electrostatic transport belt where the images are not to be applied to the print medium; (iii) measures the one or more marks applied to the electrostatic transport belt; and (iv) cleans the one or more marks off the electrostatic transport belt prior to the print medium coming into contact with that portion of the transport belt.

13. The printer as recited in claim 6, wherein the non-calibration tasks include applying images to a medium.

14. An apparatus, comprising:
a print unit configured to print one or more documents; and
a calibration unit, configured to perform a plurality of partial calibration operations alternated with one or more non-calibration operations.

15. The apparatus as recited in claim 14, wherein the print unit further comprises an electrostatic transfer belt; and wherein the calibration unit is further configured to locate an inner document gap in the one or more documents and place one or more calibration marks onto the transfer belt corresponding to the location where the inner document gap occurs.

16. The apparatus as recited in claim 14, wherein the print unit further comprises an electrostatic transfer belt; and wherein the calibration unit is further configured to (i) locate an inner document gap in the one or more documents, (ii) place one or more calibration marks onto the transfer belt corresponding to the location where the inner documents gap occurs, and (iii) clean the calibration marks off the electrostatic belt before paper comes in contact with the electrostatic belt with the one or more calibration marks.

17. The apparatus as recited in claim 14, whereby calibration operations are segmented by the one or more non-calibration operations to improve performance between calibration operations and non-calibration operations.

18. The apparatus as recited in claim 14, wherein the apparatus is a color printer.

19. The apparatus as recited in claim 14, wherein the calibration unit performs color plane registration when calibrating the print unit.

20. A calibration system operable on a printer, the calibration system configured to:
calibrate the printer by dividing a full calibration process into a plurality of partial calibration tasks; and
perform each of the plurality of partial calibration tasks between non-calibration tasks performed by the printer.

21. The calibration system as recited in claim 20, further configured to:
locate an area on a print medium where images are not to be applied by the printer; and
perform one of the plurality partial calibration tasks.

22. The calibration system as recited in claim 20, wherein the printer comprises an electrostatic transport belt for applying the images to a print medium; and wherein the calibration system is further configured to:
(i) locate an open area on the print medium where images are not to be applied to the print medium;
(ii) apply one or more print marks to a portion of the electrostatic transport belt corresponding to the open area on the print medium;
(iii) measure the one or more marks applied to the electrostatic transport belt; and
(iv) clean the one or more marks off the electrostatic transport belt prior to the print medium coming into contact with the one or more marks on the electrostatic transport belt.

23. The calibration system as recited in claim 20, wherein the non-calibration tasks include applying images to a printable medium.

24. The calibration system as recited in claim 20, wherein the full calibration process involves performing color plane registration.

25. The calibration system as recited in claim 20, wherein the full calibration process involves calibrating color densities.

26. The calibration system as recited in claim 20, wherein the full calibration process involves calibrating glossiness.
